(19) United States
(12) Patent Application Publication
(10) Pub. No.: US 2012/0075595 A1
(43) Pub. Date: Mar. 29, 2012

(54) VIDEO PROJECTOR

(75) Inventors: Yusuke YAMAMOTO, Osaka-shi (JP); Toshihiro Saruwatari, Kishiwada-shi (JP); Chao Wang, Shenzhen (CN)

(73) Assignees: Sanyo Technology Center (Shenzhen) Co., Ltd., Shenzhen (CN); Sanyo Electric Co., Ltd., Osaka (JP)

(21) Appl. No.: 13/242,579

(22) Filed: Sep. 23, 2011

(30) Foreign Application Priority Data
Sep. 29, 2010 (JP) 2010-219834

(51) Int. Cl. G03B 21/16

(52) U.S. Cl. 353/58; 353/57; 353/61

(57) ABSTRACT

A video projector including a light source used to display an image, an optical component that differs from the light source, a power supply unit that supplies power, and a centrifugal fan including a rotation shaft and a blade that rotates about the rotation shaft. The centrifugal fan is a double intake fan that draws in gas from first and second axial directions, which are parallel to the rotation shaft, by rotating the blade and sends the gas outward in a radial direction from the rotation shaft. The centrifugal fan sends gas that has cooled the optical component and the power supply unit to the light source.

### CROSS-REFERENCE TO RELATED APPLICATIONS

This application is based upon and claims the benefit of priority from prior Japanese Patent Application No. 2010-219834, filed on. Sep. 29, 2010, the entire contents of which are incorporated herein by reference.

### BACKGROUND OF THE INVENTION

The present invention relates to a video projector including a fan that cools a light source used to display an image.

A typical video projector includes a fan that cools a light source. Further, a video projector includes optical components, such as liquid crystal panels, and a power supply unit. Japanese Laid-Open Patent Publication No. 2004-54055 describes a video projector including a plurality of fans that cool optical components and a power supply unit.

Japanese Laid-Open Patent Publication No. 2009-64032 describes a cooling structure that cools a light source with an air current that flows from a fan and cools heated portions other than the light, source with an air current that is drawn into the fan.

In the video projector of the '055 publication, a housing, which accommodates the light source, is divided into a plurality of sections by partition plates. A fan is arranged in each section. As a result, it is difficult to miniaturize the video projector.

The video projector of the '032 publication is relatively compact. However, the trend for using brighter light sources has resulted in an increase in the amount of heat generated by the light source. Thus, in the structure of the '032 publication, the light source may not be sufficiently cooled by the air current from the fan.

It is an object of the present invention to provide a video projector that efficiently cools a light source, with air current that flows from a fan.

### SUMMARY OF THE INVENTION

One aspect of the present invention is a video projector including a light source used to display an image, an optical component other than the light source, a power supply unit that supplies power, and a centrifugal fan including a rotation shaft and a blade that rotates about the rotation shaft. The centrifugal fan is a double intake fan that draws in gas from first and second axial directions, which are parallel to the rotation shaft, by rotating the blade and that sends the gas outward in a radial direction from the rotation shaft. The centrifugal fan sends gas that has cooled the optical component and the power supply unit to the light source.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a) and 1(b) are perspective views showing a video pro lector according to one embodiment of the present invention;

FIG. 2 is a schematic diagram showing an optical system in a housing;

FIG. 3 is a schematic diagram showing the flow of air in the housing;

FIGS. 4(a) and 4(b) are perspective views showing a double intake fan;

FIG. 5 is a schematic diagram showing the flow of air in the housing, in which the arrows indicate the flow of air that has cooled a polarizer and liquid crystal light valves and is drawn into a first intake port of the double intake fan; and

FIG. 6 is a schematic view showing the flow of air in the housing, in which one arrow indicates the flow of air that has cooled a power supply unit and is drawn into a second intake port of the double intake fan and another arrow indicates the air discharged out of the housing by a discharge fan.

### DETAILED DESCRIPTION OF THE INVENTION

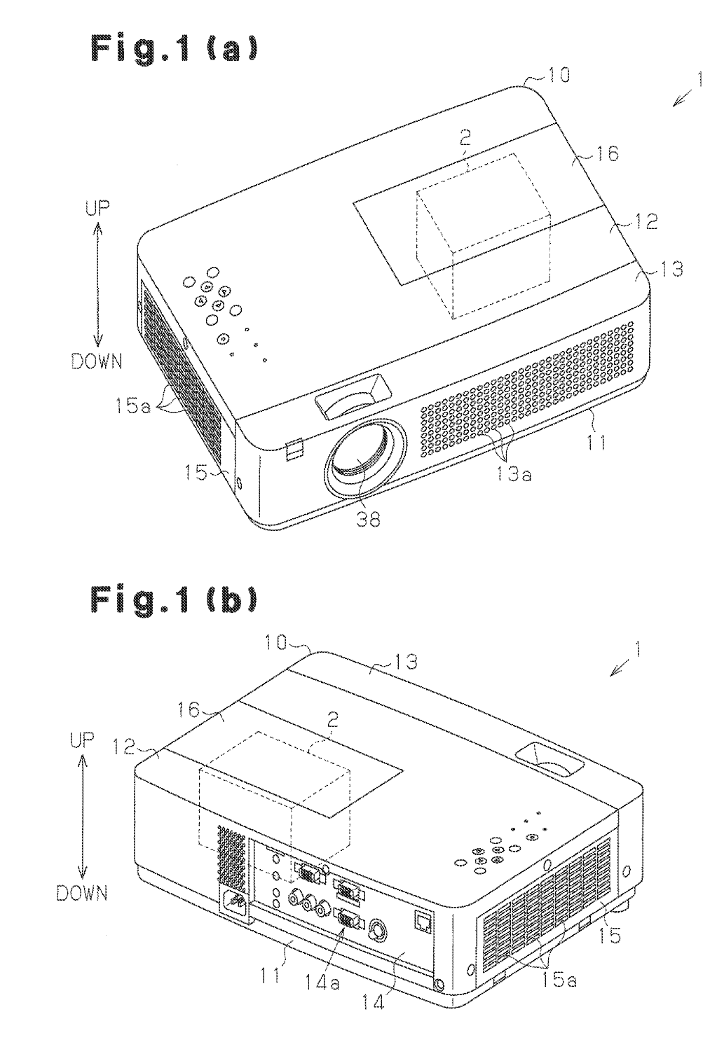

A video projector (projector 1) according to one embodiment of the present invention will now be described. In the description hereafter, the state of the projector 1 as shown in FIG. 1 will be used as the frame of reference for the upward and downward directions.

Referring to FIGS. 1(a) and 1(b), the projector 1 projects and displays an image on a projection surface such as a screen or a wall. The projector 1 includes a housing 10, which accommodates electronic and optical components.

In the example of FIG. 1, the housing 10 includes a lower case 11, an upper case 12 covering the upper side of the lower case 11, a front panel 13, a rear panel 14, a filter cover 15, and a lamp cover 16 covering a lamp 2. A projection lens 38 is arranged in the front panel 13. The rear panel 14 and front panel 13 are arranged on opposite sides of the housing 10. Various types of connection terminals are arranged in a terminal unit 14a on the rear panel 14.

The lower case 11 forms a lower wall of the projector 1. The lower case 11 includes an air inlet (not shown) through which ambient air is drawn into the housing 10. The front panel 13 and the filter cover 15 also respectively include air inlets 13a and 15a through which ambient air is drawn into the housing 10.

In this manner, the projector 1 is capable of drawing ambient air under normal temperatures into the housing 10 through the air inlets 13a and 15a. The projector 1 uses the air drawn into the housing 10 to cool cooling subjects in the projector 1.

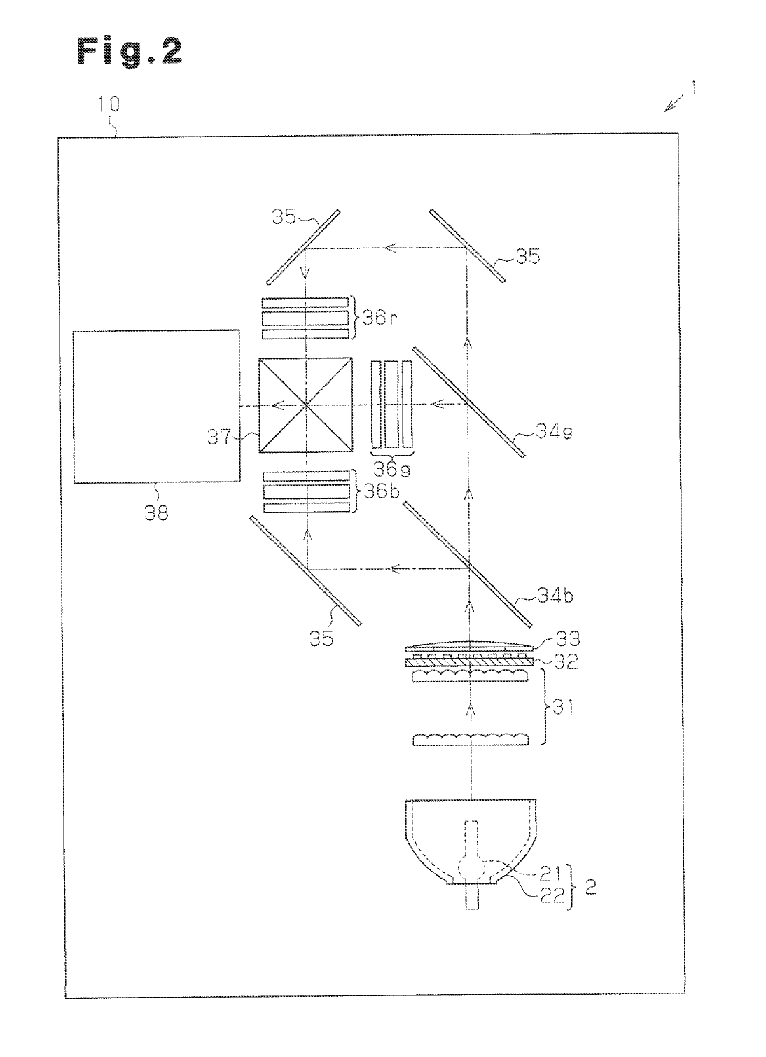

Referring to FIG. 2, the optical components of the projector 1 include the lamp 2, dichroic mirrors 34b and 34g and liquid crystal light valves 36r, 36g, and 36b. The lamp 2 serves as a light source used to display an image. The dichroic mirrors 34b and 34g separate white light into the three primary colors of light, which are red, green, and blue. The liquid crystal light valves 36r, 36g, and 36b respectively correspond to the red light, green light, and blue light. FIG. 2 is a schematic diagram showing the optical components from above.

The lamp 2 may be a discharge lamp, such as an ultrahigh pressure mercury lamp or a metal halide lamp. The lamp 2 includes an arc tube 21 and a reflector 22. A luminous body of, for example, mercury or a halogen compound is sealed in the arc tube 21. The reflector 22 reflects the light emitted from the arc tube 21 in a predetermined direction.

When the lamp 2 is supplied with power, an electrical discharge generates white light in the arc tube 21. The reflector 22 is a reflection mirror that reflects the light emitted from the arc tube 21. The lamp 2 that includes the reflector 22 guides more light to the liquid crystal light valves 36r, 36g, and 36b than a lamp that does not include the reflector 22.

The dichroic mirrors 34b and 34g and a mirror 35 guide the light from the lamp 2 to the liquid crystal, light valves 36r, 36g, and 36h. An integrator lens 31 formed by two fly's eye lenses, a polarizer 32, and a condenser lens 33 are arranged between the lamp 2 and the liquid crystal light valves 36r, 36g, and 36b. The in lens 31 functions to obtain a uniform illuminance distribution. The polarizer 32 sets polarized light in a predetermined direction. The polarizer 32 includes a polarization separation film and a phase difference plate. The polarization separation film separates the light from the lamp 2 into p-polarized light and s-polarized light. The phase difference plate converts either one of the p-polarized light and s-polarized light into the other one of the p-polarized light and s-polarized light. The condenser lens 33 converges light and provides the converged light to the liquid crystal light valves 36r, 36g, and 36b.

The dichroic mirror 34b reflects light having a wavelength corresponding to blue, and the dichroic mirror 34g reflects light having a wavelength corresponding to green. The white light from the lamp 2 is separated by the dichroic mirrors 34b and 34g into light having a wavelength corresponding to red (hereinafter referred to as red light), light having a wavelength corresponding to green (hereinafter referred to as green light), and light having a wavelength corresponding to blue hereinafter referred to as blue light).

Red light enters the liquid crystal light valve 36r. Green light enters the liquid crystal light valve 36g. Blue light enters the liquid crystal light valve 36b. Each of the liquid crystal light valves 36r, 36g, and 36b varies the transmittance of light for each of the pixels forming a single image. Further, each of the liquid crystal light valves 36r, 36g, and 36b includes a liquid crystal panel, an entrance side optical component arranged at the side in which light enters the liquid crystal panel, and an exit side optical component arranged at the side in which light exits the liquid crystal panel. The liquid crystal panel also includes at least transparent substrates sandwiching liquid crystal molecules. The entrance side optical component and exit side optical component each include at least a polarization plate.

Red light passes through the liquid crystal light valve 36r. This generates a red image. Green light passes through the liquid crystal light valve 36g. This generates a green image. Flue light, passes through the liquid crystal light valve 36b. This generates a blue image.

The optical components include a cross dichroic prism 37 and the projection lens 38. The cross dichroic prism 37 combines the images of the three primary colors. The projection lens 38 includes a group of lenses that projects the light of an image.

The cross dichroic prism 37 combines the light of the red, green, and blue images generated by the liquid crystal light valves 36r, 36g, and 36b to generate a full-color image. The full-color image is provided to the projection lens 38.

The projection lens 38 projects light of a full-color image toward a flat surface, such as a screen or a wall. As apparent from the above description, the illustrated projector 1 is a three-LCD projector.

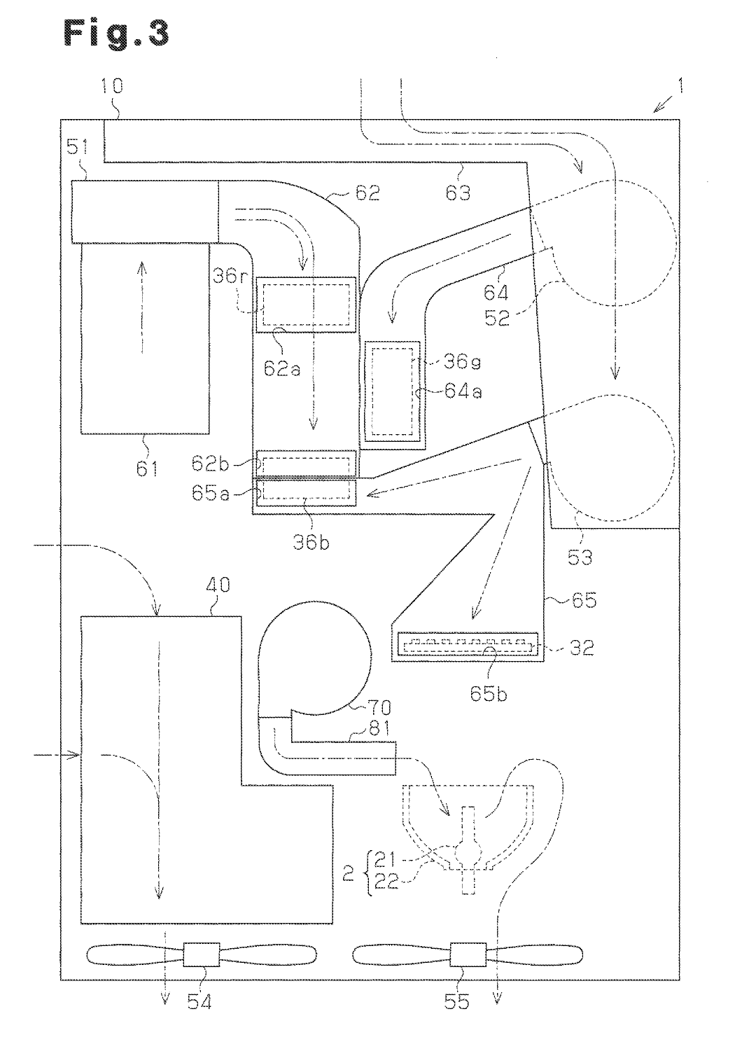

As shown in FIG. 3, a power supply unit 40 is arranged in the housing 10. FIG. 3 shows the locations of components in the housing 10 when viewing the projector from above in the same manner as in FIG. 2. The dashed lines in FIG. 3 indicate the flow of cooling air.

The power supply unit 40 obtains power from an external power supply (not shown), converts the power into power corresponding to each electrical component in the projector 1, and supplies the electrical components with power. The power supply unit 40 may be, for example, a power supply circuit including an AC-DC converter that coverts AC power from the external power supply into DC power. The electrical components of the projector 1 include the lamp 2, which generates light with an electrical discharge, the liquid crystal light valve 36r, 36g, and 36b, which varies the transmittance of light in accordance with the voltage applied to the liquid crystal, intake fans 51, 52, and 53, discharge fans 54 and 55, and a centrifugal fan 70.

Cooling subjects of the projector 1 include the polarizer 32, the liquid crystal light valves 36r, 36q, and 36b, and the power supply unit 40. To cool the cooling subjects, the projector 1 uses the intake fans 51, 52, and 53 and the discharge fans 54 and 55. The polarizer 32 and the liquid crystal light valves 36r, 36g, and 36b may be referred to as optical components that differ from the lamp 2.

The intake fans 51, 52, and 53 may each be a centrifugal fan such as a sirocco fan. The intake fans 51, 52, and 53 draw ambient gas (air) into the housing 10 and cools, among the cooling subjects, the optical components (i.e., the polarizer 32 and the liquid crystal light valves 36r, 36g, and 36b).

The intake fan 51 is connected to an intake duct 61 and a discharge duct 62. The intake an 51 draws air through the intake duct 61 from an air inlet (not shown) arranged in the lower case 11 and delivers the air to the discharge duct 62. The discharge duct 62 includes a discharge port 62a, which is arranged below the liquid crystal light valve 36r, and a discharge port 62b, which is arranged below an exit side of the liquid crystal light valve 36b. The air from the intake fan 51 is discharged from the discharge port 62a to cool the liquid crystal light valve 36r. The all discharged from the discharge port 62b cools the liquid crystal light valve 36b.

The intake fan 52 is connected to an intake duct 63 and a discharge duct 64. The intake fan 52 draws air through the intake duct 63 from the air inlet 15a, which is arranged in the filter cover 15 (refer to FIG. 1), and delivers the air to the discharge duct 64. The discharge duct 64 includes a discharge pert 64a, which is arranged below the liquid crystal light valve 36g. The air from the intake fan 52 is discharged from the discharge port 64a to cool the liquid crystal light valve 36g.

The intake fan 53 is connected to the intake duct 63 and a discharge duct 65. The intake fan 53 draws air through the intake duct 63 and delivers the air to trio discharge duct 65. The discharge duct 65 includes a discharge port 65a, which is arranged below an entrance portion the liquid crystal light valve 36b, and a discharge port 65b, which is arranged below the polarizer 32. The air from the retake fan 53 is discharged from the discharge port 65a to cool the entrance side of the liquid crystal light valve 36b. The air discharged from the discharge port 65b cools the polarizer 32.

As described above, the liquid crystal light valve 36r is cooled by the air from the intake fan 51. The liquid crystal light valve 36g is cooled by the air from the intake fan 52. The liquid crystal light valve 36b is cooled by the air from the intake fans 51 and 53. The polarizer 32 is cooled by the air from the intake fan 53.

The discharge fans 54 and 55 may each be, for example, an axial fan. The discharge fans 54 and 55 forcibly discharge gas (air) out of the housing 10 through an outlet (not shown) arranged in the housing 10.

The discharge fan 54 is arranged adjacent to the power supply unit 40. When the discharge fan 54 forcibly discharges air out of the housing 10, a pressure gradient is formed near the power supply unit 40. This draws ambient air into the housing 10 through the air inlet 13a (refer to FIG. 1), which is located adjacent to the power supply unit 40. Accordingly, when the discharge fan 54 is driven, the ambient air drawn into the housing 10 passes by and cools the power supply unit 40. In, this manner, the power supply unit 40 is cooled by the air that is drawn in when the discharge fan 54 is driven.

The discharge fan 55 is arranged adjacent to the lamp 2. When the discharge fan 55 is driven, the it that has cooled the lamp 2 is forcibly discharged out of the housing 10.

The centrifugal fan 70 that cools the lamp 2 will now be discussed.

As shown in FIG. 3, the centrifugal fan 70 is arranged adjacent to the lamp 2 between the power supply unit 40, the polarizer 32, and the liquid crystal light valves 36r, 36q, and 36b. A discharge duct 81 is connected to the centrifugal fan 79. The centrifugal fan 70 draws in the air inside the housing 10 and delivers the air to the lamp 2 through the discharge duct 81.

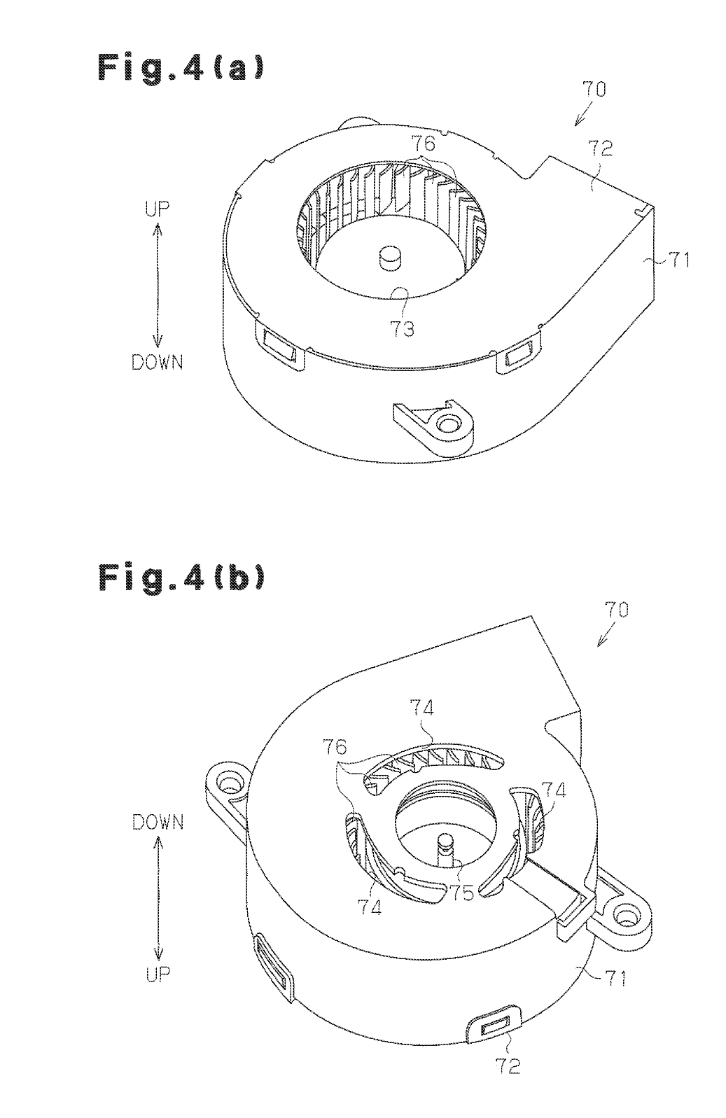

As shown in FIGS. 4(a) and 4(b), the centrifugal fan 70 includes an impeller, a first intake port 73, and a second intake port 74. The impeller is rotated about a rotation shaft 75 and includes a plurality of blades 76. The first intake port 73 and second intake port 74 draws air into the centrifugal fan 70. The impeller is accommodated in a case 71. A cover 72 covers the case 71. In the illustrated example, the first intake port 73 is formed in the cover 72, and the second intake port 74 is formed in the case 71. The first intake port 73 may be circular and concentric with the rotation shaft 75. The second intake port 74 may include a plurality of arcuate openings arranged at equal angular intervals around the rotation shaft 71. The first and second intake ports 13 and 74 face different directions.

The case 71 and the cover 72 form an internal portion of the centrifugal fan 70 that accommodates the rotation shaft 75, which functions as a rotor of a motor (not shown), and the blades 76, which rotate together with the rotation shaft 75. In the present embodiment, the blades 76 are forward-oriented blades that are oriented in the direction of rotation. The centrifugal fan 70 is a sirocco fan.

As described above, the centrifugal fan 70 is a double intake fan including the intake ports 73 and 74. When the centrifugal fan 70 rotates the blades 76 about the rotation shaft 75, air is draw in through the intake ports 73 and 74 from upward and downward directions, that is, from an axial direction parallel to the rotation shaft 75. Further, the drawn in air is sent outward in the radial direction of the rotation shaft 75. The centrifugal fan 70 draws in the air that has cooled the polarizer 32, the liquid crystal light valves 36r, 36g, and 36b, and the power supply unit 40.

As shown in FIG. 3, to deliver the air that has cooled the power supply unit 40 and the optical components, the centrifugal fan 70 is located at a position inwardly spaced from inner wall surfaces of the housing 10. In contrast, the intake fans 31, 52, and 53, which draw ambient air into the housing 10, and the discharge fans 54 and 55, which discharge air out of the housing 10, are arranged adjacent to the inner wall surfaces of the housing 10.

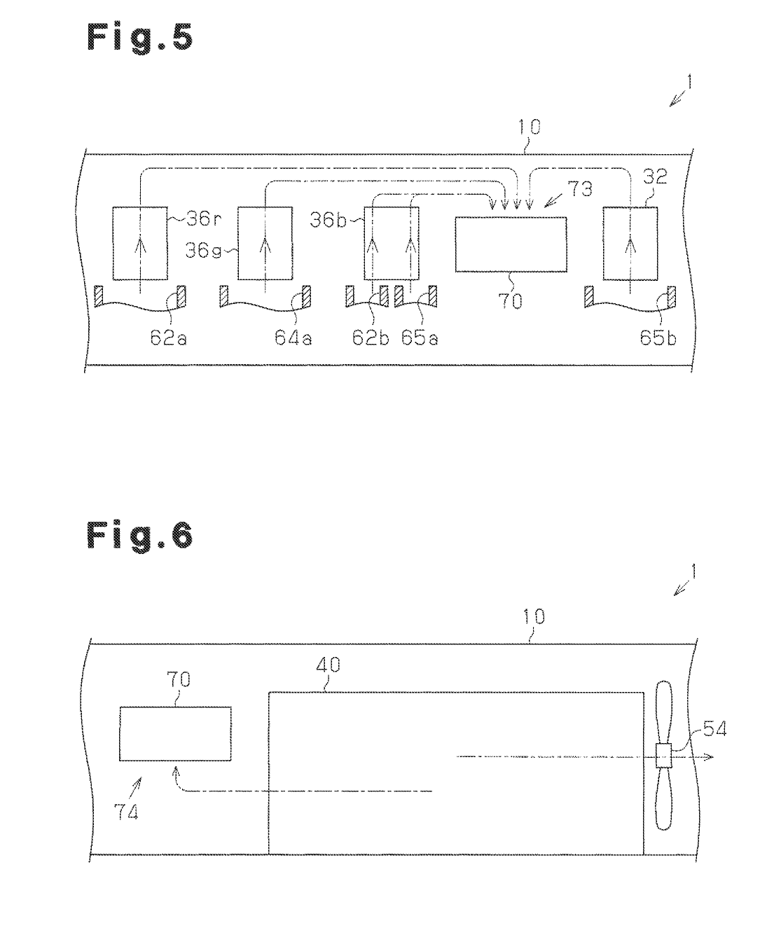

The flow of air drawn into the centrifugal fan 70 will now be described with reference to FIGS. 5 and 6. The dashed ices in FIGS. 5 and 6 show the flow of cooling air.

As shown in FIG. 5, the discharge ports 62a, 62b, 64a, 65a, and 63b discharge currents of sir in upward directions to cool the liquid crystal light valves 36r, 36g, and 36b and the polarizer 32. The centrifugal fan 70 draws in, through the upper intake port 73, the air that have passed by the liquid crystal light valves 36r, 36g, and 36b and the polarizer 32.

As shown in FIG. 6, some of the air that has cooled trio power supply unit 40 is discharged out of the housing 10 by the discharge fan 54. The centrifugal fan 70 also draws in some of the air that has cooled the power supply unit 40 through the lower intake port 74.

As described above, the centrifugal fan 70 draws in the air that has cooled the liquid crystal light valves 36r, 36g, and 36h and the polarizer 32 from above and draws in the air that has cooled the power supply unit 40 from below. The centrifugal fan 70 sends the air that has cooled the liquid crystal light valves 36r, 36g, and 36b, the polarizer 32, and the power supply unit 40 to the lamp 2. This cools the temp 2. The temperature of the air that has cooled the liquid crystal light valves 36r, 36g, and 36b, the polarizer 32, and the power supply unit 40 is significantly lower than the temperature of the lamp 2. Thus, the air current from the centrifugal fan 70 sufficiently cools the lamp 2.

The present embodiment has the advantages described below.

(1) The centrifugal fan 70 of the projector 1 rotates the blades 76 about the rotation shaft 73 to draw in air from the axial direction that is parallel to the rotation shaft 75 and send air outward in the radial direction. Further, the centrifugal fan 70 is a double intake fan that sends to the lamp 2 the air that has cooled the polarizer 32, the liquid crystal light valves 36r, 36g, and 36b, and the power supply unit 40. In comparison with a single intake centrifugal fan, the double intake centrifugal fan 70 draws in air over a larger area and ensures that a sufficient amount of air is sent to the lamp 2. This allows a light source to be sufficiently cooled with the relatively compact centrifugal fan 70.

(2) The centrifugal fan 70 includes the first intake port 73, which draws in the air that has cooled the polarizer 32 and the liquid crystal light valves 36r, 36g, and 36b from a first axial direction, and the second intake port 74, which draws in the air that has cooled the power supply unit 40 from a second axial direction. The path of the air that flows toward the centrifugal fan 70 from the polarizer 32 and the liquid crystal light valves 36r, 36g, and 36b differs from the path of the air that flows from the power supply unit 40 to the centrifugal fan 70. This facilitates the designing of the flow paths.

(3) The centrifugal fan 70 draws in the air that has cooled the liquid crystal light valves 36r, 36g, and 36b and sends the drawn in air to the lamp 2. Thus, the air that has cooled the liquid crystal light valves 36r, 36g, and 36h can be used to cool the lamp 2.

(4) The centrifugal fan 70 draws in the air that has cooled the polarizer 32 and sends the drawn in air to the lamp 2. Thus, the air that has cooled the polarizer 32 can be used to cool the lamp 2.

(5) The discharge fan 54 of the projector 1 draws in the air that has cooled the power supply unit 40 from the power supply unit 40 and discharges the air out of the housing 10. Accordingly, the air that has cooled the power supply unit 40 is drawn by the centrifugal fan 70 and the discharge fan 54. Thus, in comparison with a structure that includes only either one of the centrifugal fan 70 and the discharge fan 54, the cooling of the power supply unit 40 is enhanced.

(6) The first intake port 73 is formed in the upper surface of the centrifugal fan 70, and the second intake port 74 is formed in the lower surface of the centrifugal fan 70. Thus, the path of the air that flows from the polarizer 32 and the liquid crystal light valves 36r, 36q, and 36h and the path of the air that flows from the power supply unit 40 to the centrifugal fan 70 are formed at different levels of height. As a result, the flow paths of air in the housing 10 do not interfere with each other, and smooth flows of air are formed.

It should be apparent to those skilled in the art that the present invention may be embodied in many other specific forms without departing, from the spirit or scope of the invention. Particularly, it should be understood that the present invention may be embodied in the following forms solely or in combination.

The power supply unit 40 may supply power to only selected ones of the lamp) 2, the liquid crystal light valves 36r, 36g, and 36b, the intake fans 51, 52, and 53, the discharge fans 54 and 55, and the centrifugal fan 70.

The structure for cooling the polarizer 32 and the liquid crystal light valves 36a, 36g, and 36P may be changed. For example, the quantity, layout, and shape of the intake fans 51, 52, and 52 or the ducts 61 to 65 may be changed.

Any light source may be used as the lamp 2. For example, the light source ray be a light emitting diode (LED).

The centrifugal fan 70 draws in the air that has cooled each one of the polarizer 32 and the liquid crystal light valves 36r, 36g, and 36b. However, the centrifugal fan 70 may draw in the air that has cooled any one of the polarizer 32 and the liquid gulf crystal light valves 36r, 36g, and 36b.

The optical components that are cooling sod cots differing from the light source are not limited to the polarizer 32 and the liquid crystal light valves 36r, 36G, and 36b. Accordingly, the air drawn into the centrifugal fan 70 is not limited to the air that cools any one of the polarizer 32 and the liquid crystal light valves 36r, 36g, and 36b.

The centrifugal fan 70 is a sirocco fan. However, the centrifugal fan 70 may be a turbo fan including rearward-oriented blades. Further, the centrifugal fan 70 may include blades extending straight and outward in the radial direction.

The present examples and embodiments are to be considered as illustrative and not restrictive, and the invention is not to be limited to the details given herein, but may be modified within the scope and equivalence of the appended claims.

1. A video projector comprising:
a light source used to display an image;
an optical component other than the light source;
a power supply unit that supplies power; and
a centrifugal fan including a rotation shaft and a blade that rotates about the rotation shaft, wherein
the centrifugal fan is a double intake fan that draws in gas from first and second axial directions, which are parallel to the rotation shaft, by rotating the blade and that sends the gas outward in a radial direction from the rotation shaft; and
the centrifugal fan sends gas that has cooled the optical component and the power supply unit to the light source.

2. The video projector according to claim 1, wherein the centrifugal fan includes a first intake port, which draws in the gas that has cooled the optical component from the first axial direction, and a second intake port, which draws in the gas that has cooled the power supply unit from the second axial direction.

3. The video projector according to claim 1, wherein
the optical component includes a liquid crystal light valve, and
the centrifugal fan draws in gas that has cooled the liquid crystal light valve and sends the gas to the light source.

4. The video projector according to claim 1, wherein
the optical component includes a polarizer provided with a polarization separation film and a phase difference plate, and
the centrifugal fan draws in the gas that has cooled the polarizer and sends the gas to the light source.

5. The video projector according to claim 1, further comprising:
a housing that accommodates the power supply unit; and
a discharge fan that draws in the gas that has cooled the power supply unit and discharges the drawn in gas out of the housing.

6. The video projector according to claim 2, wherein
the centrifugal fan includes an upper surface and a lower surface, and
the first and second intake ports are respectively formed in the upper and lower surfaces of the centrifugal fan so that a flow of the gas that has cooled the optical component and a flow of the gas that has cooled the power supply unit are formed at different levels of height.

7. The video projector according to claim 1, wherein the centrifugal fan is connected to a discharge duct including a discharge port arranged in correspondence with the light source.

8. A video projector comprising:
a housing;
a light source used to display an image, wherein the light source is arranged in the housing;
an optical component that differs from the light source, wherein the optical component is arranged in the housing;
a power supply unit arranged in the housing;
an intake fan that draws ambient air into the housing, wherein the intake fan is arranged adjacent to an inner wall surface of the housing;
a first discharge fan that discharge air that has cooled the power supply unit out of the housing, wherein the first discharge fan is arranged adjacent to the inner wall surface of the housing; and
a centrifugal fan that includes an upper intake port, which is located at a position inwardly spaced from the inner wall surface of the housing, and a lower intake port, which is formed at a height that differs from that of the upper intake port, wherein the centrifugal fan draws in air that has cooled the optical component through the upper intake port, draws in some of the air that has cooled the power supply unit through the lower intake port, and discharges the drawn in air outward in a radial direction to cool the light source.

9. The video projector according to claim 8, further comprising a second discharge fan that discharges the air that has cooled the light source out of the housing, wherein the second discharge fan is arranged adjacent to the inner wall surface of the housing.
